(19) United States
(12) Patent Application Publication
(10) Pub. No.: US 2014/0353314 A1
(43) Pub. Date: Dec. 4, 2014

(54) EXTRUDED SECURITY CASE

(71) Applicants: Justen Ericksen, Kaysville, UT (US); Jeff Johnson, Kaysville, UT (US)

(72) Inventors: Justen Ericksen, Kaysville, UT (US); Jeff Johnson, Kaysville, UT (US)

(21) Appl. No.: 14/296,437

(22) Filed: Jun. 4, 2014

Related U.S. Application Data
(60) Provisional application No. 61/830,638, filed on Jun. 4, 2013.

(51) Int. Cl. B65D 43/16; B65D 6/00; E05G 1/00

(52) U.S. Cl. CPC B65D 43/164; E05G 1/00; B65D 11/00
USPC 220/315

(57) ABSTRACT

An extruded security case. The extruded security case includes an extruded base, an extruded lid, and one or more end caps. The extruded base is rotatably attached to the extruded lid by a hinge. The one or more end caps are attached to the base by a plurality of fasteners. An end cap of the one or more end caps may include a security notch for receiving a selectively securable security attachment.

### CROSS-REFERENCE TO RELATED APPLICATIONS

This application claims the benefit of U.S. Provisional Patent Application No. 61/830,638 entitled “Extruded Security Case,” which was filed on Jun. 4, 2013, and is hereby incorporated by reference.

### BACKGROUND

More and more people are storing firearms in their homes for personal protection purposes. Many gun safes, however, are heavy, large, and cumbersome to open. While these safes can present a very secure storage device, they can be difficult to access or move. When a gun safe is not easily accessible because of its size or because of the slow and cumbersome locking mechanism, it will not provide users with an easily accessible personal safety option.

Gun safes are designed primarily to keep the firearms safe from children or others who may try to gain access without permission. More and more people today own and keep firearms in their home for security and protection purposes. The problem with most gun safes large enough to hold rifles or shotguns is that they most normally are stored in a place that in inaccessible in times of emergency because of their size. Most gun safes, moreover, have a standard combination lock that prove difficult to open in times of distress.

### SUMMARY

Embodiments are disclosed that provide a security case. The security case may be made using extruded parts. The security case may include a base and a lid connected via an integrated hinge. End caps may be secured to opposing ends of the base. The security case may provide secure and portable storage for a firearm or other valuable items.

### BRIEF DESCRIPTION OF THE SEVERAL VIEWS OF THE DRAWINGS

FIGS. 1A and 1B depict perspective views of one embodiment of an extruded security case.

FIGS. 2A and 2B depict perspective views of one embodiment of the extruded security case of FIG. 1A.

FIG. 3 depicts a side view of one embodiment of the extruded security case of FIG. 1A with an end cap removed.

FIGS. 4A-4C depict perspective views of embodiments of the base of FIG. 1A.

FIG. 5 depicts a side view of one embodiment of end cap of FIG. 1A.

FIG. 6 depicts a perspective view of one embodiment of an extruded security case.

FIG. 7 depicts a side view of one embodiment of the extruded security case of FIG. 6 with an end cap removed.

FIG. 8 depicts a perspective view of one embodiment the extruded security case of FIG. 6 with an end cap removed.

FIG. 9 depicts a perspective view of one embodiment the extruded security case of FIG. 6 with an end cap removed.

FIG. 10 depicts a top view of one embodiment the extruded security case of FIG. 6 showing the lock.

FIG. 11 depicts a top view of the lock cam of FIG. 7.

FIG. 12 depicts a perspective view of an embodiment of the end cap of FIG. 6.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments provide an extruded security case. The extruded security case may be selectively lockable. In certain embodiments, the extruded security case is configured for storing a firearm.

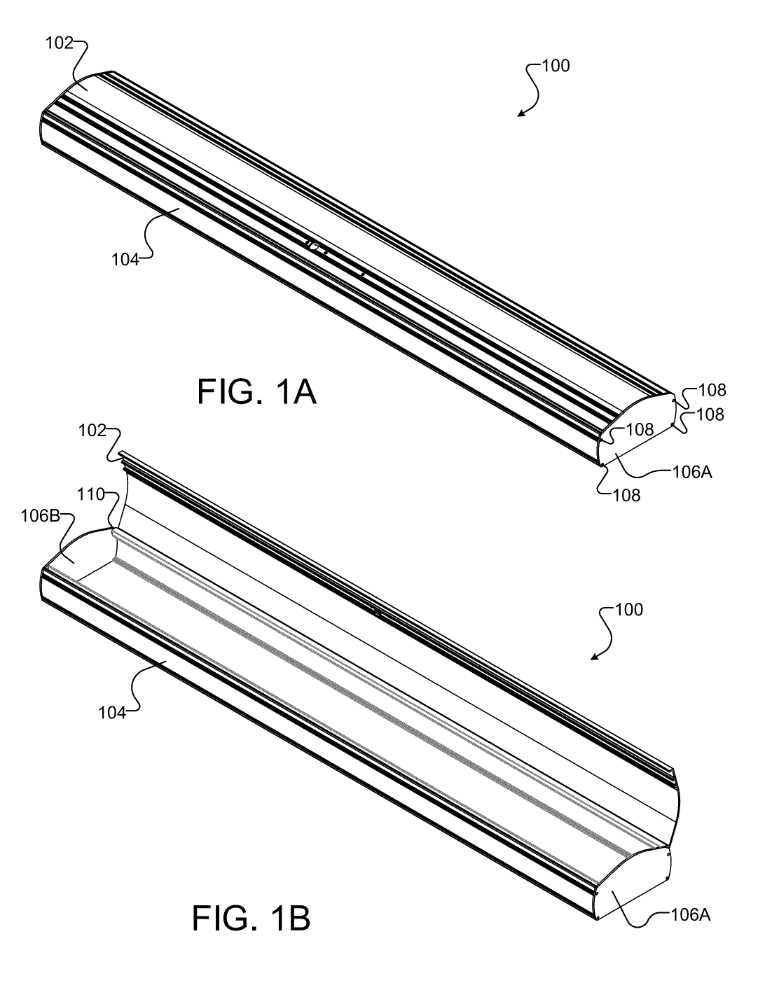

FIGS. 1A and 1B depict perspective views of one embodiment of an extruded security case 100. The extruded security case includes a lid 102, a base 104, and two end caps 106A, 106B (collectively, “end caps 106”). The extruded security case 100 may be selectively opened and closed.

The lid 102, in one embodiment, is an extruded body having a substantially constant profile along its extrusion axis. The lid 102 may include any material having the desired strength, stiffness, or other mechanical properties. For example, in one embodiment, the lid 102 may be formed from aluminum. In some embodiments, the lid 102 may be formed from steel, another metal, an alloy, a polymer, or a composite material.

The lid 102 may be treated or coated. For example, the lid 102 may be anodized, powder coated, or painted. As will be appreciated by one skilled in the art, the lid 102 may receive any treatment or coating known in the art to provide desired mechanical properties, environmental protection, or appearance.

In some embodiments, the lid 102 may have a curved or dome shaped profile. The curved or dome shaped profile may act to inhibit attempts to compromise the structure of the lid to gain access to the inside of the extruded security case 100. The lid 102 may have other features or components integrally formed or added thereto. The lid 102 is described in greater detail in relation to the other figures below.

The base 104, in one embodiment, is an extruded body having a substantially constant profile along its extrusion axis. The base 104 may include any material having the desired strength, stiffness, or other mechanical properties. For example, in one embodiment, the base 104 may be formed from aluminum. In some embodiments, the base 104 may be formed from steel, another metal, an alloy, a polymer, or a composite material.

The base 104 may be treated or coated. For example, the base 104 may be anodized, powder coated, or painted. As will be appreciated by one skilled in the art, the base 104 may receive any treatment or coating known in the art to provide desired mechanical properties, environmental protection, or appearance.

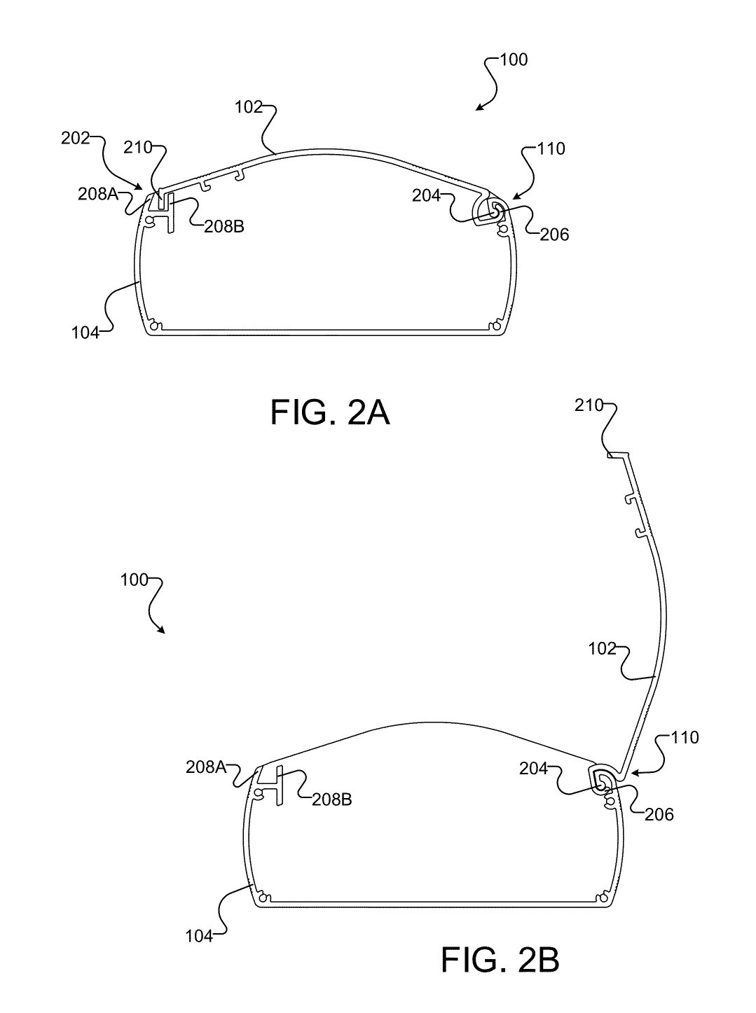

The base 104 may include features or components integrally formed or added thereto. In some embodiments, the base 104 may include structure to interface with a corresponding structure on the lid 102 to form a hinge 110. The hinge 110 may secure the lid 102 to the base 104 and allow the lid 102 to pivot relative to the base 104 such that the lid may be opened and closed. The hinge 110 is described in greater detail below in relation to FIGS. 2A and 2B.

In some embodiments, the end caps 106 are connected to opposing ends of the base 104. In one embodiment, each end cap 106A, 106B is connected to the base 104 by a plurality of fasteners 108. The fasteners 108 may be any type of fastener known in the art. For example, the fasteners 108 may be screws, security screws, or rivets. In another embodiment, the end caps 106 may be connected to the base 104 by welding or gluing. In yet another embodiment, the end caps 106 may be formed integrally with the base 104, such as by casting the base 104 with integral end caps.

FIGS. 2A and 2B depict perspective views of one embodiment of the extruded security case 100 of FIG. 1A with an end cap 106A removed. The lid 102 and the base 104 interface with one another at a hinge 110 and an anti-pry interface 202. The lid 102 and the base 104 interact to allow the lid 102 to open relative to the base 104 when unlocked, and to resist prying when locked.

The hinge 110, in one embodiment, includes a pivot 204 and a slide 206. The slide 206 slides around the pivot 204 to allow the lid 102 to open. In the illustrated embodiment, the pivot 204 is formed on the base 104 and the slide 206 is formed on the lid. The pivot 204 and the slide 206 may be formed integrally with the base 104 and the lid 102 respectively as the base 104 and the lid 102 are extruded. As will be appreciated by one skilled in the art, in an alternative embodiment, the pivot 204 may be formed on the lid 102 and the slide 206 may be formed on the base 104.

In some embodiments, the slide 206 and the pivot 204 are formed such that they interfere with one another when the lid 102 is opened to a certain position. This interference may prevent the lid 102 from opening further and support the lid 102 in an open position. FIG. 2B illustrates the lid 102 opened to essentially a fully opened position, wherein the structure of the pivot 204 and the slide 206 resist further opening of the lid 102.

The anti-pry interface 202, in one embodiment, includes a plurality of anti-pry lips 208A, 208B (collectively “anti-pry lips 208”) and an anti-pry flange 210. The anti-pry lips 208 may be disposed on opposite sides of the anti-pry flange 210 when the lid 102 is closed. The anti-pry lips 208 may interact with the anti-pry flange 210 such as to support the anti-pry flange 210 and resist insertion of a pry tool. In the illustrated embodiment, the anti-pry lips 208 and the anti-pry flange 210 are formed integrally with the base 104 and the lid 102 respectively as the base 104 and the lid 102 are extruded. As will be appreciated by one skilled in the art, in an alternative embodiment, the anti-pry lips 208 may be formed on the lid 102 and the anti-pry flange 210 may be formed on the base 104.

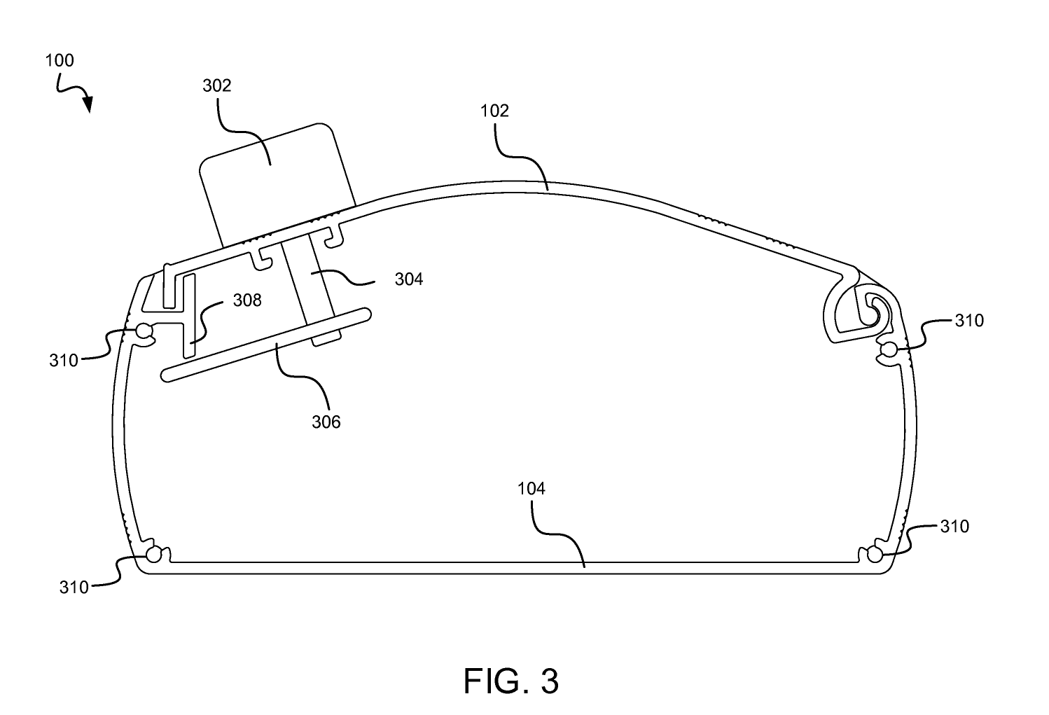

FIG. 3 depicts a side view of one embodiment of the extruded security case 100 of FIG. 1A with an end cap 106A removed. The extruded security case 100 includes a lock 302. The lock 302 selectively resists opening of the lid 102 relative to the base 104.

The lock 302, in one embodiment, includes a shaft 304 and a cam 306. The lock 302 transmits rotation through the shaft 304 to the cam 306 in response to actuation of the lock 302. In the illustrated embodiment, the lock 302 is attached to the lid 102. In an alternative embodiment, the lock 302 is attached to the base 104.

The lock 302 may be any type of lock known in the art, including but not limited to a combination lock, a key lock, or a biometric lock. In one embodiment, the lock 302 is an electronic combination lock wherein the lock 302 permits rotation of an actuator in response to entry of a correct code on a keypad.

The cam 306, in some embodiments, rotates from an engaged position to a disengaged position in response to rotation transmitted by the shaft 304. The lock 302 may transmit rotation to the shaft 304. In the engaged position (illustrated in FIG. 3), the cam 306 interferes with a lock structure 308 in response to an attempt to move the lid 102 to an open position. In the disengaged position, the cam 306 may not interfere with the lock structure 308 such that the lid 102 may be moved from a closed position to an open position.

The cam 306 may be any material known in the art strong and rigid enough to resist a predetermined force applied to open the lid 102. For example, in one embodiment, the cam may be made from steel. In some embodiments, the cam 306 may be made from aluminum, steel, another metal, an alloy, a polymer, a composite material, or a combination of materials.

The lock structure 308, in some embodiments, is formed integrally with one of the lid 102 or the base 104. In the illustrated embodiment, the lock structure 308 is formed integrally with the base 104. In an alternative embodiment, the lock structure 308 is formed integrally with the lid 102. In some embodiments, the lock structure 308 is a separate component attached to the lid 102 or the base 104.

In the illustrated embodiment, the lock structure 308 is a flange disposed on the base 104. In an alternative embodiment, the lock structure 308 may be any structure capable of interacting with the cam 306 to restrict movement of the lid 102 relative to the base 104. For example, the lock structure 308 may be a slot, a flat surface, or a contoured surface.

The base 104, in some embodiments, includes one or more screw bosses 310. The screw bosses may provide a connection point for one or more fasteners 108. In one embodiment, the screw boss 310 is a substantially semi-circular structure configured to receive a fastener 108. For example, the screw boss 310 may bound an open-sided, semi-circular aperture into which a screw may be fastened.

The screw bosses 310 may be disposed on open ends of the base 104. The screw bosses 310 may be used to attach the end caps 106 to the base 104 via the fasteners 108. In one embodiment, the fasters 108 may be security screws configured to allow tightening of the screws but not facilitating loosening of the screws. In another embodiment, the security screws may require a special tool for removal. In yet another embodiment, the fasteners 108 may be rivets that engage the screw bosses 310.

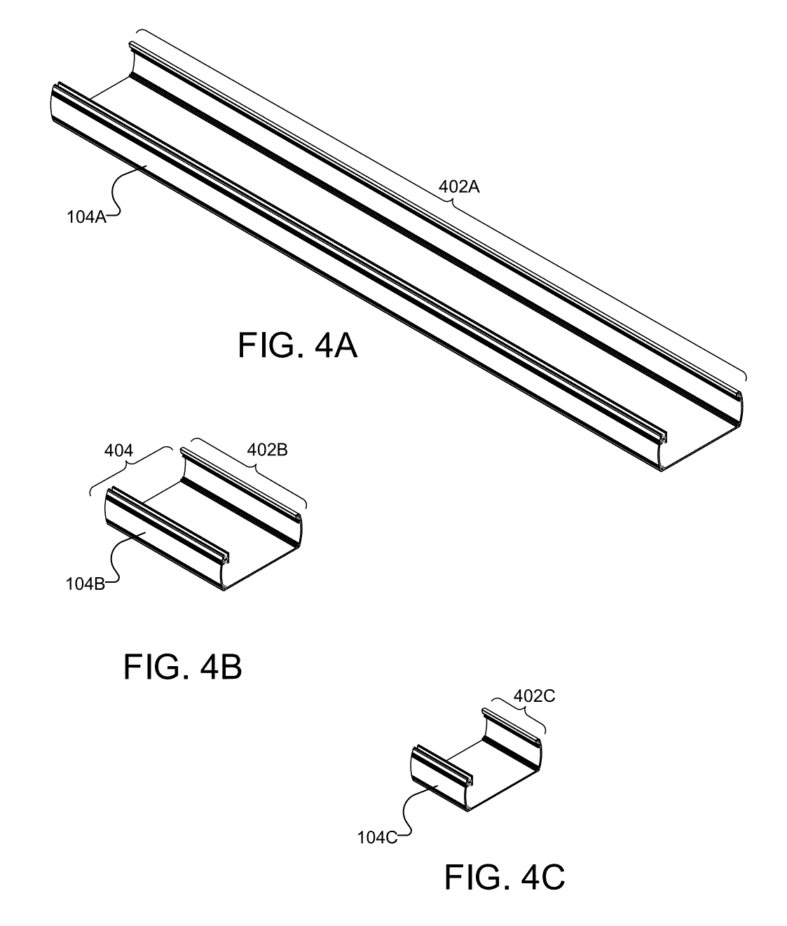

FIGS. 4A-4C depict perspective views of embodiments of the base 104 of FIG. 1A. The base 104 may have a length along its extrusion axis that accommodates a particular use. The lid 102 may be formed in a length along its extrusion axis to substantially match the length of the base 104.

For example, the base 104 may be sized to accommodate a shotgun or rifle having a length 402A as shown by base 104A. In some embodiments, the length 402A may be approximately fifty (50) inches. In some embodiments, the length 402A is between forty (40) and sixty (60) inches. In another embodiment, the length 402A is between approximately fifteen (15) and eighty (80) inches.

In another example, the base 104 may be sized to accommodate a plurality of handguns having a length 402B as shown by base 104B. In some embodiments, the length 402B may be approximately nine and seven eighths (9 ⅞) inches. In some embodiments, the length 402B is between eight (8) and fifteen (15) inches.

In yet another example, the base 104 may be sized to accommodate a compact handgun having a length 402C as shown by base 104C. In some embodiments, the length 402C may be approximately four (four) inches. In some embodiments, the length 402A is between three (3) and eight (8) inches.

The base 104 may have a width 404 perpendicular to the extrusion axis. The width may be sized to accommodate a particular use. The lid 102 may have a corresponding width to substantially match the width 404 of the base 104. In one embodiment, the width 404 may be approximately six and one half (6 ½) inches. In another embodiment, the width 404 may be between approximately five (5) and ten (10) inches. In another embodiment, the width 404 may be between approximately three (3) and fifteen (15) inches.

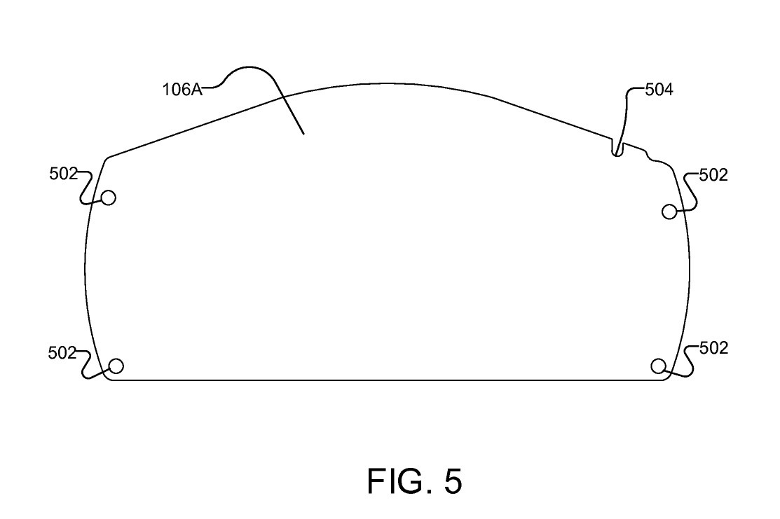

FIG. 5 depicts a side view of one embodiment of end cap 106A of FIG. 1A. The end cap 106A, in one embodiment, encloses the ends of the base 104 and the lid 102. The end cap 106A may be any material having adequate strength and rigidity for the extruded security case 100. End cap 106A may be substantially similar to end cap 106B. In another embodiment, end cap 106A and end cap 106B may have different structures, functions, and or features.

In one embodiment, the end cap 106A includes a plurality of apertures 502. The apertures 502 may be positioned to align with screw bosses 310 on the base 104. The apertures 502 may be sized to receive fasteners 108 to connect the end cap 106A to the base 104.

In some embodiments, the end cap 106A includes a security notch 504. The security notch 504 may be sized to receive a security attachment (not shown) to selectively secure the extruded security case 100 to a fixed object. The security attachment may be placed in the security notch 504 while the lid 102 is open relative to the base 104. While in the closed position, the lid 102 may interfere with removal of the security attachment. For example, the security attachment may be a cable with an enlarged end. The cable may be sized to fit in the security notch 504, while the enlarged end may be sized such that it cannot pass through the security notch 504. Thus, the cable may be seated in the security notch with the enlarged end within the extruded security case 100 while the lid 102 is open relative to the base 104. When the lid 102 is closed relative to the base 104, the enlarged end may be too large to pass through the security notch 504, effectively securing the cable to the extruded security case 100.

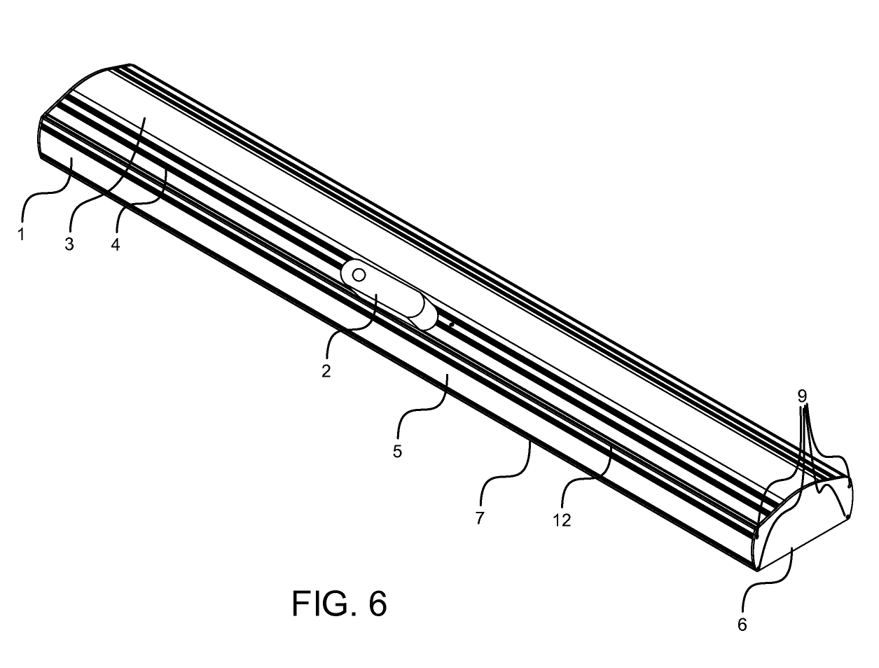

FIG. 6 depicts a perspective view of one embodiment of an extruded security case 1. An electronic combination lock 2 is located approximately in the middle of the extruded security case 1. The extruded security case 1 is made of extruded aluminum. Grip ridges 4 on the surface of a curved lid 3 are created when the lid 3 is extruded. On a bottom 7 of the extruded security case 1, grip ridges are also created in the extrusion process. End caps 6 are constructed of aluminum, steel or other metal. The end caps 6 are affixed to the extruded security case 1 by means of fasteners 9, such as rivets or screws. Steel or metal fasteners are inserted into extruded screw bosses 10 on the inside of the extruded security case 1. On an inside of the end caps 6, there is a lid base 18 that receives the lid and locking rods 13 to stops the in the desired location for locking Sidewalls 5 of the extruded security case 1 are also extruded in a curved shape. Anti-pry lips 12 are created as part of the front side wall 5, and form a groove or indention into which a lip of the lid 3 is received.

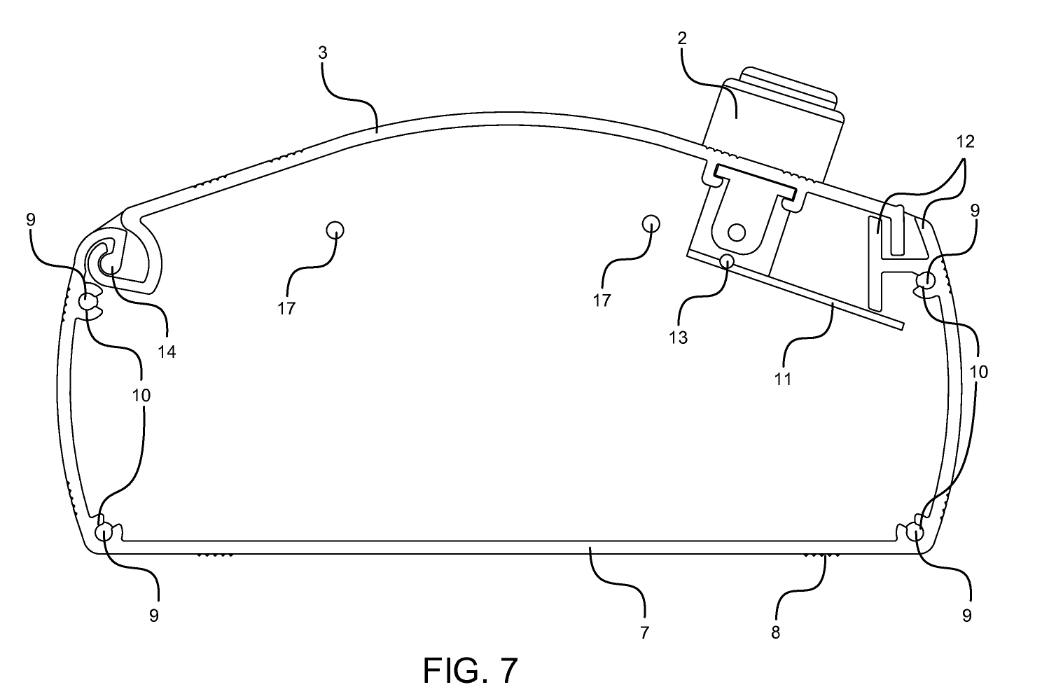

FIG. 7 depicts a side view of one embodiment of the extruded security case 1 of FIG. 6 with an end cap 6 removed and showing an integrated hinge 14 that is extruded as part of the back sidewall of a base of the extruded security case 1 and the lid 3. The screw bosses 10 receive the steel or metal fasteners 9 and may be disposed in bottom 7 corners of the base, the tops of the sides 5 of the base and near the top of the end caps 6. The end caps 6 are affixed to the gun safe 1 by use of the fasteners 9 in screw boss 10 locations. The anti-pry lips 12 are shown as part of the front side wall 5 of the base. A lip of the lid 3 is shown in the closed position between the anti-pry lips 12. A cam 1 of an electronic lock 2 is shown with locking rods 13 that proceed laterally from the lock 2 to the end caps 6. The cam 11 is shown in a locked position resting underneath the anti-pry lips 12, creating an integrated locking shelf.

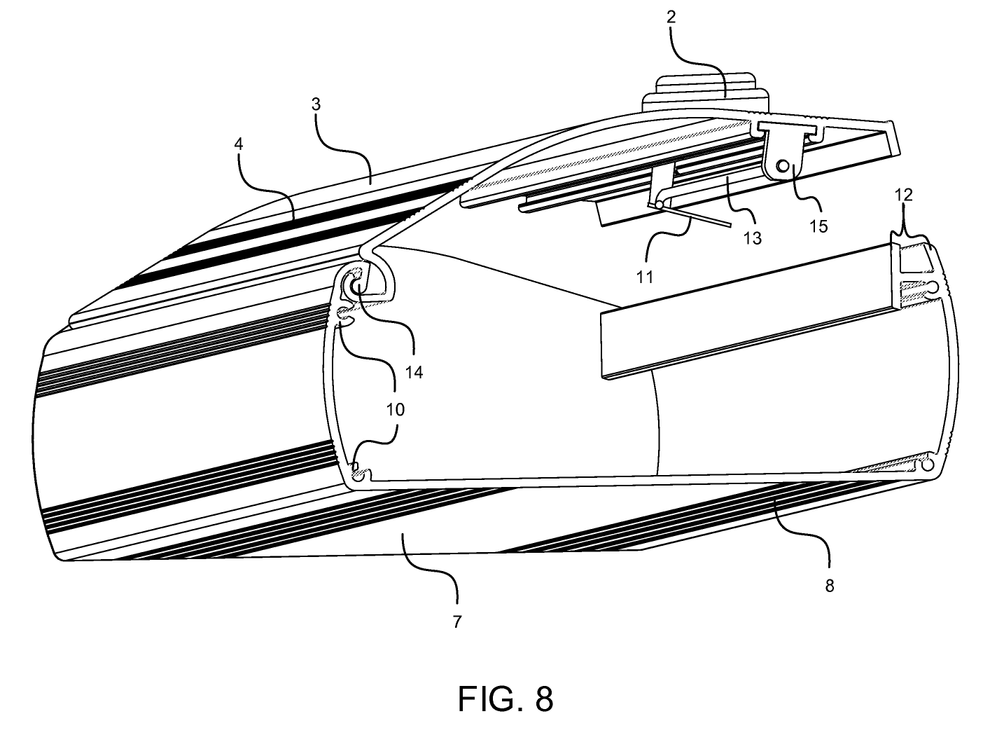

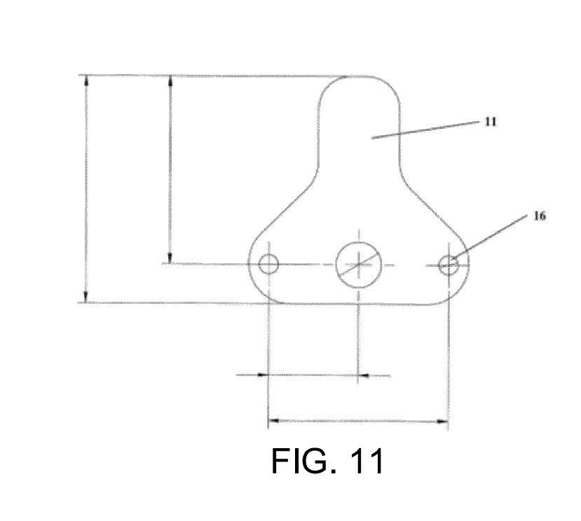

FIG. 8 depicts a perspective view of one embodiment the extruded security case 1 of FIG. 6 with an end cap 6 removed. Extruded grip rides 4, 8 on the bottom 7 and lid 3 of the extruded security case 1 are depicted. The attachment of the locking rods 13 to the cam 11 of the lock 2, may be accomplished by hooks on a lock-end of the locking rods 13 which pass through the holes 16 (see FIG. 11) on the cam 11 configured to receive the locking rod 13. Also depicted are locking rod guides 15. The locking rod guides 15 may be any material having appropriate strength and rigidity, such as metal or hardened plastic. The locking rod guides 15 may be located on each end of the lid 3 and direct the locking rods 13 into the pre-drilled holes 17 of the lid base 18 to lock ends of the lid 3 to the end caps 6. In one embodiment, the lid 3 is locked in three places by the cam 11 and the locking rods 13 at each end of the extruded security case 1. The integrated locking shelf created by the anti-pry lips 12 extends the length of the extruded security case 1, adding strength and stability. The integrated hinge 14 is shown in the open position illustrating how the hinge 14 may resist tampering (e.g., cannot be disassembled).

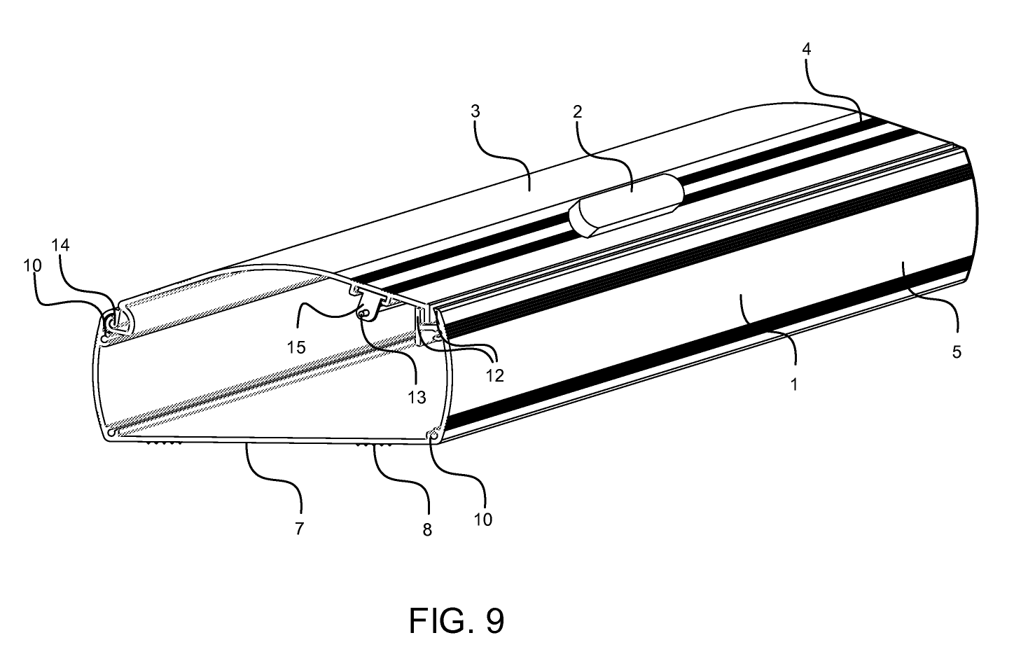

FIG. 9 depicts a perspective view of one embodiment the extruded security case 1 of FIG. 6 with an end cap 6 removed. In FIG. 9, the lid 3 is in a closed position and the lock 2 is engaged. This depiction shows the locking rod 13 extended, so as to be received by the pre-drilled holes 17 of the lid base 18. The anti-pry lips 12 are shown encasing the lip of the lid 3.

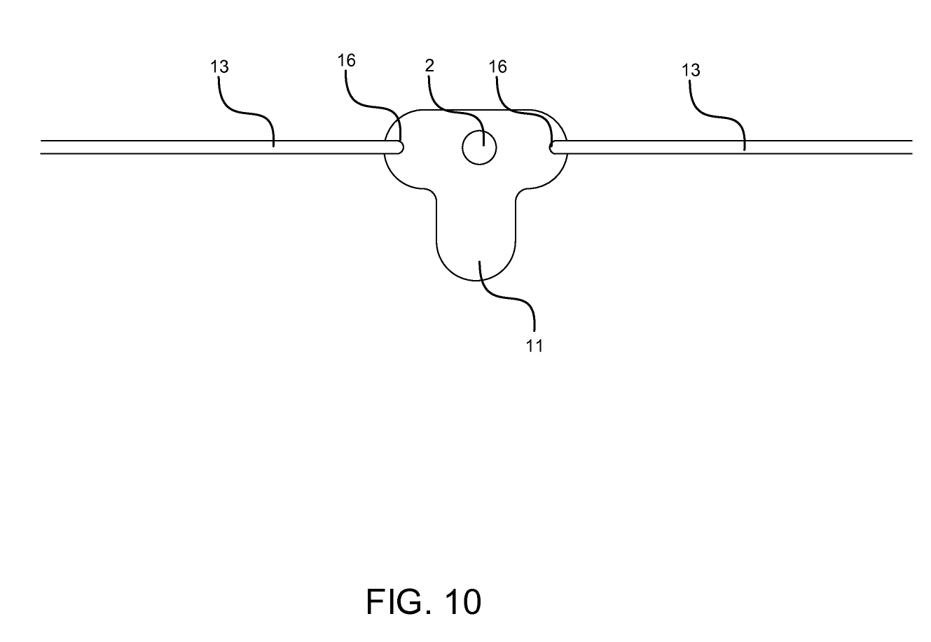

FIG. 10 depicts a top view of one embodiment the extruded security case 1 of FIG. 6 showing the lock 2. The locking rods 13 are attached to apertures 16 in the cam 11. Rotation of the cam 11 causes extension or retraction of the locking rods 13. Rotation of the cam 11 selectively places a portion of the cam 11 underneath the anti-pry lips 12, restricting opening of the lid 3.

FIG. 11 depicts a top view of the lock cam 11 of FIG. 7. An arm of the cam (opposite the apertures 16) rests underneath the anti-pry lips 12 when the lock 2 is in a locked position. The apertures 16 receive the locking rods 13.

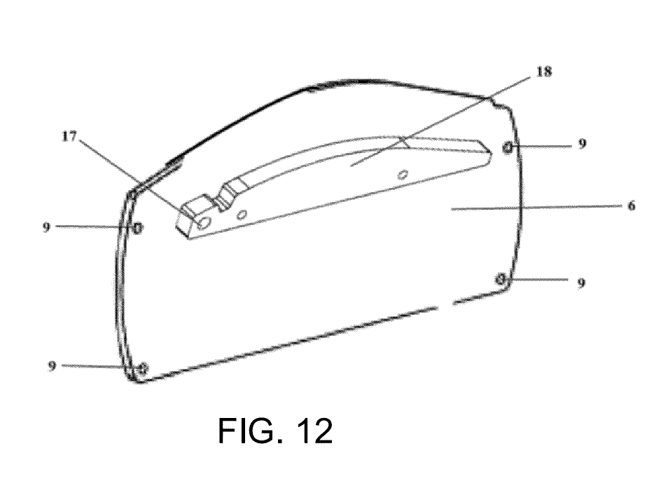

FIG. 12 depicts a perspective view of an embodiment of the end cap 6 of FIG. 6. The lid base 18 interfaces with and supports the lid 3 when the lid 3 is in a closed position. The fasteners 9 secure the end cap 6 to the base. The pre-drilled hole receive the locking rods 17 when the lock 2 is placed in the locking position.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, keypads, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although specific embodiments of the invention have been described and illustrated, the invention is not to be limited to the specific forms or arrangements of parts so described and illustrated. The scope of the invention is to be defined by any claims appended hereto and their equivalents.

What is claimed is:

1. An extruded security case comprising:
an extruded base;
an extruded lid rotatably attached to the extruded base by a hinge;
one or more end caps attached to the base by a plurality of fasteners; and
a security notch formed in one of the one or more end caps for receiving a selectively securable security attachment.

2. The extruded security case of claim 1, wherein the securable security attachment comprises a cable sized to fit in the security notch with an enlarged end that is too large to pass through the security notch when the extruded lid is closed.

3. The extruded security case of claim 1, wherein the hinge comprises an extruded structure of the extruded lid and an extruded structure of the extruded base.

4. The extruded security case of claim 1, wherein the hinge comprises an extruded pivot on one of the extruded base and the extruded lid and an extruded slide on the other of the extruded base and the extruded lid.

5. The extruded security case of claim 4, wherein the extruded lid and the extruded base interfere with one another when the extruded lid is rotated relative to the extruded base to a predetermined position.

6. The extruded security case of claim 1, further comprising a plurality of anti-pry lips on one of the extruded base and the extruded lid and an anti-pry flange on the other of the extruded base and the extruded lid.

7. The extruded security case of claim 6, wherein the anti-pry flange is disposed substantially between the anti-pry lips when the extruded lid is in a closed position relative to the extruded base.

8. The extruded security case of claim 1, wherein the extruded base and the extruded lid have substantially the same longitudinal length.

9. The extruded security case of claim 8, wherein the extruded base and the extruded lid are each between forty and sixty inches long.

10. The extruded security case of claim 8, wherein the extruded base and the extruded lid are each between eight and 15 inches long.

11. The extruded security case of claim 8, wherein the extruded base and the extruded lid are each between three and eight inches long.

12. An extruded security case comprising:
an extruded base;
an extruded lid rotatably attached to the extruded base by a hinge; and
one or more end caps attached to the base by a plurality of fasteners.

13. The extruded security case of claim 12, wherein the hinge comprises an extruded structure of the extruded lid and an extruded structure of the extruded base.

14. The extruded security case of claim 12, wherein the hinge comprises an extruded pivot on one of the extruded base and the extruded lid and an extruded slide on the other of the extruded base and the extruded lid.

15. The extruded security case of claim 14, wherein the extruded lid and the extruded base interfere with one another when the extruded lid is rotated relative to the extruded base to a predetermined position.

16. The extruded security case of claim 12, further comprising a plurality of anti-pry lips on one of the extruded base and the extruded lid and an anti-pry flange on the other of the extruded base and the extruded lid.

17. The extruded security case of claim 16, wherein the anti-pry flange is disposed substantially between the anti-pry lips when the extruded lid is in a closed position relative to the extruded base.

18. The extruded security case of claim 12, wherein the extruded base and the extruded lid have substantially the same longitudinal length.

19. The extruded security case of claim 18, wherein the extruded base and the extruded lid are each between forty and sixty inches long.

20. The extruded security case of claim 8, wherein the extruded base and the extruded lid are each between eight and 15 inches long.
